(19) United States
(12) Patent Application Publication
(10) Pub. No.: US 2014/0018171 A1
(43) Pub. Date: Jan. 16, 2014

(54) SETTING A LOCKING STATE FOR A GAMING MACHINE

(71) Applicant: Li Wei, Reno, NV (US)

(72) Inventor: Li Wei, Reno, NV (US)

(73) Assignee: IGT

(21) Appl. No.: 13/548,028

(22) Filed: Jul. 12, 2012

(51) Int. Cl. G06F 19/00

(52) U.S. Cl. 463/36

(57) ABSTRACT

Methods and systems for setting a locking state for a gaming machine include receiving a command to set the locking state for the gaming machine, providing a signal to enter the locking state for the gaming machine, determining an interval of time to enter the locking state for the gaming machine; and releasing the gaming machine from the locking state.

### BACKGROUND

1. Field of the Described Implementations

The present disclosure relates generally to gaming machines, and more particularly to setting a locking state for the gaming machine.

2. Description of the Related Art

Many of today's gaming casinos and other entertainment locations feature different single and multi-player gaming systems such as slot machines and video poker machines. The gaming machines may include a number of hardware and software components to provide a wide variety of game types and game playing capabilities. Exemplary hardware components may include bill validators, coin acceptors, card readers, keypads, buttons, levers, touch screens, coin hoppers, ticket printers, player tracking units and the like. Software components may include, for example, boot and initialization routines, various game play programs and subroutines, credit and payout routines, image and audio generation programs, various component modules and a random or pseudo-random number generator, among others.

Gaming machines are highly regulated to ensure fairness. In many cases, gaming machines may be operable to dispense monetary awards of a large amount of money. Accordingly, access to gaming machines is often carefully controlled. For example, in some jurisdictions, routine maintenance requires that extra personnel (e.g., gaming control personnel) be notified in advance and be in attendance during such maintenance. Additionally, gaming machines may have hardware and software architectures that differ significantly from those of general-purpose computers (PCs), even though both gaming machines and PCs employ microprocessors to control a variety of devices. For example, gaming machines may have more stringent security requirements and fault tolerance requirements. Additionally, gaming machines generally operate in harsher environments as compared with PCs.

In many casinos and other entertainment locations, the gaming machines may be networked to one or more devices that monitor the functions of the gaming machines during operation. For example, an accounting system may monitor the amount of money received by a gaming machine and the amount of money paid out by the gaming machine. Such an accounting system allows the operator of the gaming machines to analyze the profitability of the gaming machines. Discrepancies in the counts may also be easily identified by comparing the electronic count to a physical count of the money collected from a gaming machine by a worker.

A gaming machine may need to be locked in some instances. For example, the mechanical arm of a gaming machine may be locked into a fixed position by using a solenoid within the mechanical arm. In this implementation, the arm may be unlocked upon receiving a wager for game play, causing a signal from a controller to the solenoid to actuate the solenoid, to allow the player to pull the mechanical arm and initiate game play.

In other implementations, the player may want to initiate the locking of the gaming machine. For example, the player may want to take a break to eat, to use the restroom, to find a friend, etc. The player may have to locate an attendant to lock the gaming machine, ask a friend to stay at the gaming machine, place an item at the machine to informally “hold” the gaming machine, etc. However, it may be inefficient or ineffective to secure the gaming machine using these methods.

### SUMMARY

According to various examples, a method of setting a locking state for a gaming machine is disclosed. The method includes receiving, via an interface, a command to set the locking state for the gaming machine. The method also includes providing a signal to enter the locking state for the gaming machine. The method further includes determining an interval of time to enter the locking state for the gaming machine, wherein the determination is based on a player profile. The method includes releasing the gaming machine from the locking state based on the interval of time or based on a release command received from the interface.

According to one example implementation, a controller for a gaming machine is disclosed. The controller includes a processor configured to execute an interface. The processor is also configured to receive a command, from the interface, to set a locking state for the gaming machine. The processor is configured to provide a signal to enter the locking state for the gaming machine. The processor is yet further configured to determine an interval of time to enter the locking state for the gaming machine, wherein the determination is based on a player profile. The processor is also configured to release the gaming machine from the locking state based on the interval of time or based on a command received from the interface.

According to another example implementation, a computer-readable storage medium is disclosed. The storage medium has machine instructions stored therein, the instructions being executable by a processor to cause the processor to perform operations. The operations include receiving, via an interface, a command to set a locking state for the gaming machine. The operations also include providing a signal to enter the locking state for the gaming machine. The operations further include determining an interval of time to enter the locking state for the gaming machine, wherein the determination is based on a player profile. The operations include releasing the gaming machine from the locking state based on the interval of time or based on a command received from the interface.

### BRIEF DESCRIPTION OF THE DRAWINGS

The details of one or more implementations are set forth in the accompanying drawings and the description below. Other features, aspects, and advantages of the disclosure will become apparent from the descriptions, the drawings, and the claims, in which:

FIG. 1 is an illustration of a gaming machine, according to an exemplary implementation;

FIG. 2 is an illustration of a gaming environment, according to an exemplary implementation;

FIG. 3 is a block diagram of a gaming machine in communication with an repository, according to an exemplary implementation; and

FIG. 4 is a flow diagram of a process for integrating a thin client game with a gaming machine, according to an exemplary implementation.

### DETAILED DESCRIPTION

Numerous specific details may be set forth below to provide a thorough understanding of concepts underlying the described implementations. It may be apparent, however, to one skilled in the art that the described implementations may be practiced without some or all of these specific details. In other instances, some process steps have not been described in detail in order to avoid unnecessarily obscuring the underlying concept.

In some implementations, the player may initiate the locking of the gaming machine by interacting with the gaming machine. For example, the interface of the gaming machine may include a locking mechanism, such as a button, for the player to lock the machine for an interval of time. In some implementations, the locking mechanism is keyed to the player profile, such as a loyalty account, reward program, etc., by providing different intervals of time for locking the gaming machine. For example, a player at the entry level of the loyalty account may have a shorter interval of time in which to lock the gaming machine as compared to a player at an intermediate level. In some implementations, a charge may be associated with the interval of time. For example, the player may be provided with an option to pay a fee to lock the gaming machine. The more a player is willing to spend, the longer the player can lock the machine. In other implementations, the play may be provided with an option to lock a gaming machine based on game play. For example, a player that has been at a gaming machine for a predetermined amount of time may be provided with an option to lock the gaming machine to take periodic breaks (e.g., to use restroom facilities). In some implementations, the player may be required to cash out before locking the gaming machine. In another implementation, the player may only lock one machine at a time.

The gaming environment (e.g., the casino) may configure the player-implemented locking as well as the interval of time that the player can lock the gaming machine. For example, the locking mechanism may be enabled or disabled in the gaming environment, such as a by technician.

The gaming machine may be unlocked by the player, using their loyalty card, entering a password-login, or other appropriate method. In some implementations, the gaming machine may automatically unlock if it is not unlocked by the player within the allowed interval of time. In another implementation, the gaming machine may be unlocked by a technician.

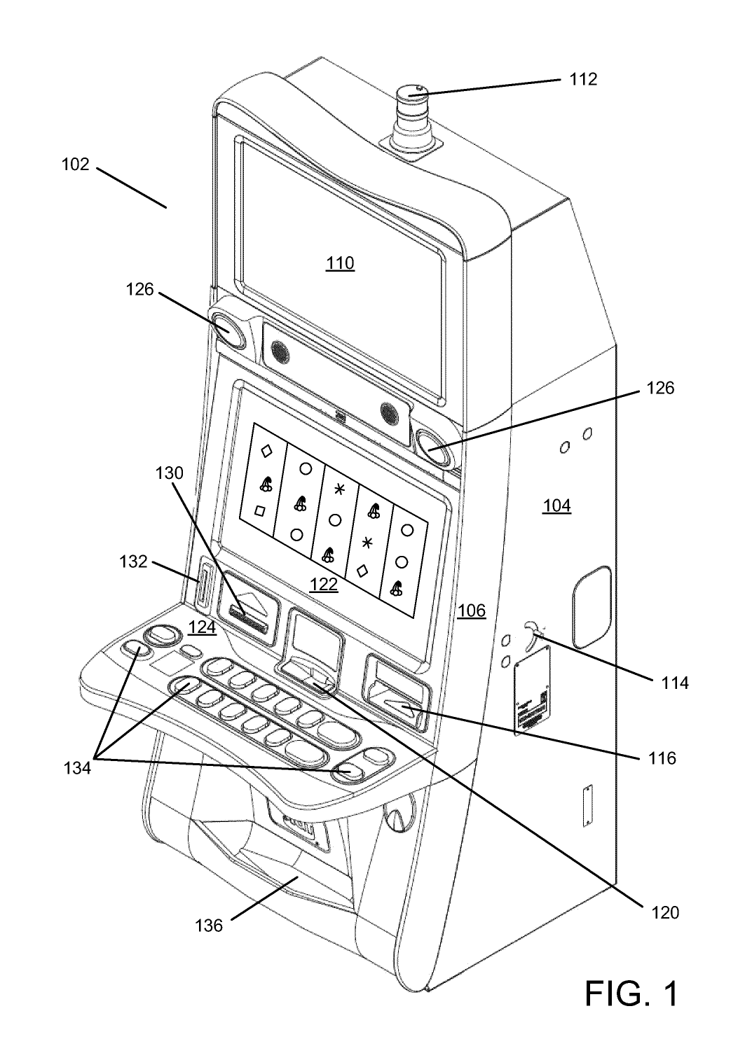

Referring to FIG. 1, a perspective drawing of an electronic gaming machine 102 is shown in accordance with described implementations. Gaming machine 102 may include a main cabinet 104. Main cabinet 104 may provide a secure enclosure that prevents tampering with device components, such as a game controller and a coin hopper (not shown) located within the interior of main cabinet 104. Main cabinet 104 may include an access mechanism, such as a door 106, which allows the interior of gaming machine 102 to be accessed. Actuation of a door 106 may be controlled by a locking mechanism 114. In some implementations, locking mechanism 114, door 106, and the interior of main cabinet 104 may be monitored with security sensors of various types to detect whether the interior has been accessed. For instance, a light sensor may be provided within main cabinet 104 to detect a change in light-levels when door 106 is opened and/or an accelerometer may be attached to door 106 to detect when door 106 is opened.

Gaming machine 102 may include any number of user interface devices that convey sensory information to a user and/or receive input from the user. For example, gaming machine 102 may include a first electronic display 110, a second electronic display 122, speakers 126, and/or a candle device 112 to convey information to the user of gaming machine 102. Gaming machine 102 may also include a console 124 having one or more inputs 134 (e.g., buttons, track pads, etc.) configured to receive input from a user. In one implementation, display 110 may also be a touch screen display configured to receive input from a user. A controller (not shown) within gaming machine 102 may run a game, such as a wager-based game, in response to receiving input from a user via inputs 134 or display 110. For example, inputs 134 may be operated to place a wager in the game and to run the game. In response, the controller may cause electro-mechanical reels 122 to spin, such as with a slot game, and/or display 110 to display the results of the game.

Gaming machine 102 may also include devices for conducting a wager-based game. For example, gaming machine 102 may include a coin acceptor 132, a printer 120, a bill acceptor 116, and a coin tray 136. Gaming machine 102 may receive physical money and/or tokens via coin acceptor 132 and bill acceptor 116 and dispense physical money or tokens via coin tray 136. Gaming machine 102 may convert received money or tokens into game credits, which may be used within the gaming establishment in lieu of money. In some cases, gaming machine 102 may also receive and dispense credits. For example, printer 120 may print a ticket for larger payouts that can be redeemed for physical money. In some cases, bill acceptor 116 may be configured to redeem a payout ticket in the form of game credits. Such a configuration may allow a user to transfer credits between gaming machines. According to various implementations, gaming machine 102 may record data regarding its receipt and/or disbursement of money or credit. Gaming machine 102 may provide such accounting data to a remote repository.

In one implementation, gaming machine 102 may include a loyalty card acceptor 130. In general, a loyalty card may be tied to a user's loyalty account. A loyalty account may store various information about the user, such as the user's identity, the user's gaming preferences, the user's gaming habits (e.g., which games the user plays, how long the user plays, etc.), a user's favorite drink, or similar information about the user. A loyalty account may also be used to reward a user for playing gaming machine 102. For example, a user having a loyalty account may be given a bonus turn on gaming machine 102 or credited loyalty points for playing gaming machine 102. Such loyalty points may be exchanged for loyalty rewards (e.g., a free meal, a free hotel stay, discounts, etc.).

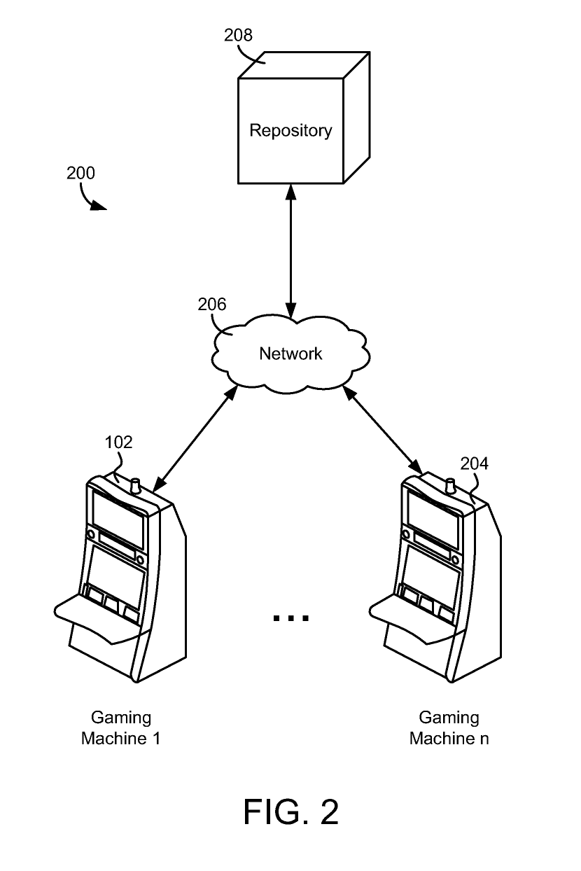

Referring now to FIG. 2, an illustration of a gaming environment 200 is shown, according to an exemplary implementation. Gaming environment 200 may be within, for example, a casino, a racetrack, a hotel, or other entertainment location. As shown, gaming environment 200 may include any number of gaming machines. For example, gaming environment 200 may include gaming machine 102 shown in FIG. 1 through a gaming machine 204 (i.e., a first gaming machine through nth gaming machine). Gaming environment may also include a network 206 through which gaming machines 102, 204 communicate with a repository 208. In some implementations, gaming machines 102, 204 may also communicate with each other via network 206.

Network 206 may be any form of communications network that conveys data between gaming machines 102, 204 and repository 208. Network 206 may include any number wired or wireless connections. For example, repository 208 may communicate over a wired connection that includes a serial cable, a fiber optic cable, a CAT5 cable, or any other form of wired connection. Similarly, repository 208 may communicate via a wireless connection (e.g., via WiFi, cellular, radio, etc.). Network 206 may also include any number of intermediary networking devices, such as routers, switches, servers, etc.

Repository 208 may be one or more electronic devices connected to network 206 configured to collect data from gaming machines 102, 204. For example, repository 208 may be a single computer, a collection of computers, or a data center. Repository 208 may include one or more data storage devices in communication with one or more processors. The data storage devices may store machine instructions that, when executed by the one or more processors, cause the one or more processors to perform the functions described with regard to repository 208. Generally, repository 208 is configured to receive and store data regarding gaming machines 102, 204 and to provide the data to a user interface (e.g., a display, a handheld device, etc.). In some cases, repository 208 may perform data analysis on the received data. For example, repository 208 may determine averages, trends, metrics, etc., for one or more of gaming machines 102, 204. Data may be sent by gaming machines 102, 204 to repository 208 in real-time (e.g., whenever a change in credits or cash occurs, whenever another type of system event occurs, etc.), periodically (e.g., every fifteen minutes, every hour, etc.), or in response to a request from repository 208.

The data received by repository 208 from gaming machines 102, 204 via network 206 may include accounting data. Accounting data may be, but is not limited to, data indicative of cash or credits received by gaming machines 102, 204 and cash or credits paid out by gaming machines 102, 204. The accounting data may also include data regarding the amount of money added or removed from gaming machines 102, 204 by the operator of the establishment. For example, a casino worker may periodically collect money from gaming machines 102, 204 and/or restock the supply of coins in gaming machines 102, 204. Repository 208 may process the collected accounting data and generate one or more reports regarding the financial state of gaming machines 102, 204 (e.g., that a collection should be made from a machine, that additional coins should be added to a machine, the amount of money a machine has generated, etc.).

The data received by repository 208 may include operational data. In general, operational data may be any other form of data indicative of the operational state of gaming machines 102, 204. For example, operational data may include data indicative of the number of games played on gaming machines 102, 204, the types of games played on gaming machines 102, 204, errors or alerts generated by gaming machines 102, 204, whether gaming machines 102, 204 are currently in use, etc. Repository 208 may use the received operational data to allow gaming machines 102, 204 to be monitored. Repository 208 may also provide notifications, if maintenance is required for any of gaming machines 102, 204. For example, a notification may be sent to a display (e.g., a display attached to repository 208, a display of a handheld device operated by a technician, etc.), so that an error may be corrected.

In some implementations, the data received by repository 208 may include data related to a user's loyalty account. For example, a user of gaming machine 102 may link their loyalty account to gaming machine 102, so that she can gain loyalty points, free turns, etc., while playing gaming machine 102. A user may link his or her loyalty account to gaming machine 102 in any number of ways. For example, the user may insert a loyalty card into gaming machine 102 and/or provide biometric data to gaming machine 102 (e.g., by conducting a finger print scan, a retinal scan, etc.). In some cases, a mobile device operated by the user may provide data regarding the user's loyalty account to gaming machine 102. The mobile device may transfer data to gaming machine 102 wirelessly (e.g., via Bluetooth, WiFi, etc.), via a wired connection (e.g., via a USB cable, a docking station, etc.), or even via the user's body (i.e., the mobile device transmits data through the user's body and into gaming machine 102). Repository 208 may then associate the user's time playing gaming machine 102 with the user's loyalty account (e.g., to add loyalty points to the user's account, to provide certain rewards to the user, such as a bonus turn, etc.).

Repository 208 may provide data to gaming machines 102, 204 via network 206. For example, repository 208 may notify a user of gaming machine 102 that the user qualifies for a loyalty award, such as a free meal, a free night in a hotel, a discount, a bonus turn, or other loyalty-related information. In some cases, repository 208 may provide a service window to gaming machines 102, 204. For example, the service window may appear within a Flash application executed by gaming machines 102, 204. A service window may allow notifications to be provided by repository 208 to an individual user during game play. In some implementations, the service window may also be configured to perform other functions, such as allowing the player to order a drink, make dinner reservations, order tickets to a show, pay taxes on a large payout, and perform other functions.

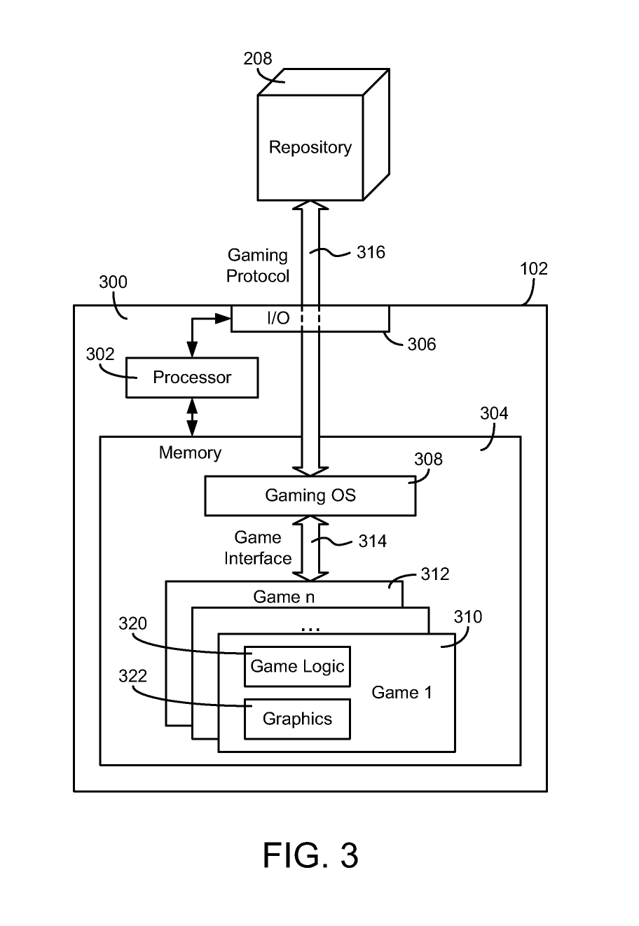

Referring now to FIG. 3, a block diagram of gaming machine 102 in communication with repository 208 is shown, according to an exemplary implementation. As shown, gaming machine 102 may include a controller 300 that controls some or all of the operations of gaming machine 102. For example, controller 300 may provide control commands to an electronic display (e.g., display 110 shown in FIG. 1), to cause the display to show certain indicia. Similarly, controller 300 may communicate with repository 208 via input and output (I/O) hardware 306.

Controller 300 may include a processor 302 and a memory 304. Memory 304 stores machine instructions that, when executed by processor 302, cause processor 302 to perform one or more operations described herein. Processor 302 may include a microprocessor, FPGA, ASIC, any other form of processing electronics, or combinations thereof. Memory 304 may be any electronic storage medium such as, but not limited to, a floppy disk, a hard drive, a CD-ROM, a DVD-ROM, a magnetic disk, RAM, ROM, EEPROM, EPROM, flash memory, optical memory, or combinations thereof. Memory 304 may be a tangible storage medium that stores non-transitory machine instructions. Controller 300 may include any number of processors and memories. In other words, processor 302 may represent the collective processing devices of controller 300 and memory 304 may represent the collective storage devices of controller 300. Processor 302 and memory 304 may be on the same printed circuit board or may be in communication with each other via a bus or other form of connection.

I/O hardware 306 includes the interface hardware used by controller 300 to receive data from other devices and/or to provide data to other devices. For example, a command may be sent from controller 300 to a controlled device of gaming machine 102 via I/O hardware 306. I/O hardware 306 may include, but is not limited to, hardware to communicate on a local system bus and/or on a network. For example, I/O hardware 306 may include a port to transmit display data to an electronic display and another port to receive data from repository 208 via a network, such as network 206 shown in FIG. 2.

Memory 304 may store games 310-312 (e.g., a first through nth game) for execution by processor 302. In one implementation, games 310-312 may be thick-client games. In other words, each game in memory 304 may include all of the logic to run the game and determine the outcome of the game. For example, game 310 may include graphics 322 (e.g., the display data for the game provided to an electronic display) and game logic 320 (e.g., the logic used to conduct the game and determine its outcome). Game logic 320 may include one or more pseudo-random number generators used to determine the outcome of the particular game. Games 310-312 may be of a certain type or may be of varying types. For example, games 310-312 may be different slot games or game 310 may be a slot game and game 312 may be a poker game. Games 310-312 may be installed in memory 304 by a technician or may be installed remotely by repository 208.

In various implementations, gaming machine 102 may use a “state” machine architecture. In a state machine architecture, critical information in each state is identified and queued for storage to memory 304. The architecture does not advance to the next state from a current state until all of the critical information that is queued for storage for the current state is stored to persistent memory. Thus, if an error condition occurs between two states, such as a power failure, gaming machine 102 can be restored to its last state prior to the occurrence of the error condition by using the critical information associated with its last stored state. This feature is often called a “roll back” of the gaming machine. Examples of critical information can include, but are not limited to, an outcome determined for one of games 310-312, a wager amount made in one of games 310-312, an award amount associated with the outcome, credits available, and/or the amount of credits deposited to gaming machine 102.

Memory 304 may include a gaming operating system (OS) 308 that controls the execution of games 310-312. For example, gaming OS 308 may control which of games 310-312 are loaded into RAM for execution by processor 302. Gaming OS 308 may also provide a game interface 314, which passes data between a game, such as game 310, and gaming OS 308. For example, game logic 320 may determine the results of game 310 and provide an indication of the results to gaming OS 308 via game interface 314 (e.g., game 310 may provide accounting data to gaming OS 308). Gaming OS 308 may provide accounting data collected from games 310-312 to repository 208. Gaming OS 308 may also provide other data to repository 208, such as operational data (e.g., system alerts, errors, etc.) or data regarding a loyalty program. Gaming OS 308 may also receive data from repository 208. For example, gaming OS 308 may receive player notifications from repository 208 and provide the notifications to the display of gaming machine 102 (e.g., as part of a displayed service window).

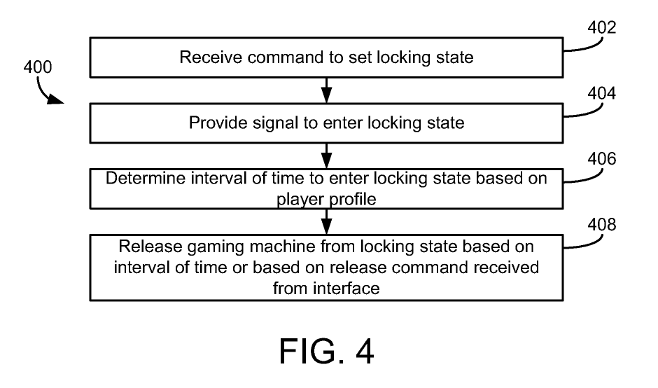

Referring now to FIG. 4, a flow diagram of a process 400 for setting a locking state for a gaming machine using a player-accessible locking mechanism is shown, according to an exemplary implementation. Process 400 may be implemented by one or more processors executing machine instructions stored within one or more computer storage devices. For example, process 400 may be implemented by a gaming machine, such as gaming machine 102 shown in FIGS. 1-3.

As previously indicated, the locking mechanism may be made available to players on various bases according to various implementations. In some implementations, the locking mechanism is keyed to a player profile, such as a loyalty account, reward program, and so on. For example, in some implementations, the locking mechanism is made available only to players that have a loyalty account with the casino in which the gaming machine 102 is located, with the manufacturer of the gaming machine, and/or with other entities. As another example, the availability of the locking mechanism may be further dependent on rewards points accumulated in such loyalty programs. In other implementations, the locking mechanism is made available to all players. For example, the locking mechanism may be made available for free or for payment of a fee. In another implementation, the locking mechanism is made available to players based on game play. For example, a player that has been at a gaming machine for a predetermined amount of time may be provided with an option to lock the gaming machine to take periodic breaks (e.g., to use restroom facilities).

Process 400 includes receiving a command to set the locking state for the gaming machine (block 402). The command may be provided via an interface which may be selected by the player. The interface may a player-accessible input device (e.g., a button) located on an exterior of the gaming machine. For example, the interface may comprise a button located on one of the display screens 110, 122 of the gaming machine 102. As another example, the interface may comprise a separate physical button located on the exterior housing of the gaming machine 102.

According to various implementations, the manner in which such an interface is provided may depend on the basis upon which the locking mechanism is made available. For example, if the locking mechanism is made available only to some players (e.g., those players with loyalty accounts), the locking mechanism may be made available via a touchscreen button presented one of the displays 110, 122. For example, the button may be displayed to those players for whom the locking mechanism is made available and may not be displayed to those players for whom the locking mechanism is not made available. As another example, the button may be displayed to all players, but may be dimmed for those players for whom the locking mechanism is not made available.

Process 400 includes providing a signal to enter the locking state for the gaming machine (block 404). The signal may be provided to a controller within the gaming machine 102. The signal may be provided, via network 206, to a server or another component in communication with the gaming machine 102. In some implementations, various interlock conditions may need to be met before any such locking signal is generated. For example, the player may be required to cash out before locking the gaming machine 102. Hence, in order for the locking signal to be generated, a determination may be made as to whether the player has cashed out of the gaming machine 102. In another implementation, the player may only lock one machine at a time. Hence, in order for the locking signal to be generated, a determination may be made via network 206 whether the player has locked any other gaming machines on the casino floor.

Process 400 includes determining a maximum interval of time during which the locking state for the gaming machine should be maintained (block 406). In some embodiments, the determination may be made based on a player profile. For example, the player profile may be stored in the repository 208 and retrieved upon player log-in, receipt of a loyalty card into the gaming machine, etc. In some implementations, the maximum interval is the same for all players. For example, a standard one hour maximum interval may be set for all players and for all circumstances.

In some implementations, the maximum interval may depend on the player's behavior in the gaming environment. The player profile may include data relating to the rating of the player, demographics of the player, playing history, etc. The player profile may also include data provided by the player, online activity or offline activity of the player, casino activity, etc. In some implementations, the player profile may have ratings based on the type of game played within a gaming environment, such as table games, slot machines, and so on.

Process 400 also includes releasing the gaming machine 102 from the locking state based on the interval of time or based on a release command received from the interface (block 408). For example, the player may re-insert the player's loyalty card back into the gaming machine 102. As another example, if the maximum time interval for the locking mechanism is set at one hour, the gaming machine 102 may automatically unlock after one hour. In some implementations, the release command is configured by the gaming environment, such as the casino.

Process 400 may also include providing reporting data related to setting the locking state to a repository. For example, reporting data may include data related to the gaming experience, such as the player's profile, awarded incentives, etc. The reporting data may be provided to the repository using a gaming protocol. The gaming protocol may include SAS or G2S protocol. Process 400 may also include receiving the reporting data at an operating system of the gaming machine. The operating system may be configured to use the gaming protocol to provide the reporting data to the repository.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A method of setting a locking state for a gaming machine comprising a processor, the method comprising:
receiving, by the processor, via an interface, a command to set the locking state for the gaming machine, the interface comprising a player-accessible input device located on an exterior of the gaming machine;
providing, by the processor, a signal to enter the locking state for the gaming machine based on a player profile stored on a loyalty card;
determining, by the processor, a maximum interval of time to enter the locking state for the gaming machine, based on online activity of the player; and
releasing, by the processor, the gaming machine from the locking state based on the interval of time or based on a release command received from the interface.

2. The method of claim 1, further comprising
retrieving, by the processor, the player profile from a repository; and
providing, by the processor, reporting data related to setting the locking state to a repository, wherein the reporting data is provided to the repository using a gaming protocol.

3. The method of claim 1, wherein the player profile comprises a loyalty program account.

4. The method of claim 1, further comprising:
providing, by the processor, a command, via the interface, to cash out credits when setting the locking state.

5. The method of claim 1, wherein the release command is configured by a gaming machine operator.

6. The method of claim 5, wherein the configurable release command is enabled or disabled by the gaming machine operator.

7. The method of claim 1, wherein the release command is received from a touch screen display via the interface.

8. The method of claim 1, wherein the release command is received from a button on the gaming machine via the interface.

9. The method of claim 1, wherein the interface is a graphical user interface.

10. A controller for a gaming machine comprising:
a processor configured to:
execute an interface, the interface comprising a player-accessible input device located on an exterior of the gaming machine;
receive a command, from the interface, to set a locking state for the gaming machine;
provide a signal to enter the locking state for the gaming machine based on a player profile stored on a loyalty card;
determine a maximum interval of time to enter the locking state for the gaming machine, based on online activity of the player; and
release the gaming machine from the locking state based on the interval of time or based on a command received from the interface.

11. The controller of claim 10, wherein the process is configured to
provide reporting data related to setting the locking state to a repository.

12. The controller of claim 10, wherein reporting data is provided to the repository using a gaming protocol.

13. The controller of claim 10, wherein the player profile comprises a loyalty program account.

14. The controller of claim 10, wherein the processor is configured to:
provide a command, via the interface, to cash out credits when setting the locking state.

15. The controller of claim 10, wherein the release command is configured by a gaming machine operator.

16. The controller of claim 15, wherein the configurable release command is enabled or disabled by the gaming machine operator.

17. The controller of claim 10, wherein the release command is received from a touch screen display via the interface.

18. The controller of claim 10, wherein the release command is received from a button on the gaming machine via the interface.

19. The controller of claim 10, wherein the processor is configured to:
execute the locking state of the gaming machine; and
provide an indication of the interval of time of the locking state to the repository using the gaming protocol.

20. A non-transitory computer-readable storage medium having machine instructions stored therein, the instructions being executable by a processor to cause the processor to perform operations comprising:
receiving, via an interface, a command to set a locking state for the gaming machine, the interface comprising a player-accessible input device located on an exterior of the gaming machine;
providing a signal to enter the locking state for the gaming machine based on a player profile stored on a loyalty card;
determining a maximum interval of time to enter the locking state for the gaming machine, based on online activity of the player; and
releasing the gaming machine from the locking state based on the interval of time or based on a release command received from the interface.
